(19) United States
(12) Patent Application Publication
(10) Pub. No.: US 2014/0269400 A1
(43) Pub. Date: Sep. 18, 2014

(54) BROADCASTING SHORT INTERFRAME SPACE INFORMATION FOR LOCATION PURPOSES

(71) Applicant: QUALCOMM Incorporated, San Diego, CA (US)

(72) Inventors: Carlos Horacio ALDANA, Mountain View, CA (US); Vinay Sridhara, Santa Clara, CA (US); Sven Fischer, Nuremberg (DE); Hui Chao, San Jose, CA (US); Sandip Homchaudhuri, San Jose, CA (US); James Simon Cho, Mountain View, CA (US); Xiaoxin Zhang, Sunnyvale, CA (US)

(21) Appl. No.: 13/826,116

(22) Filed: Mar. 14, 2013

(51) Int. Cl. H04W 24/08

(52) U.S. Cl. CPC H04W 24/08
USPC 370/253

(57) ABSTRACT

A method and apparatus for broadcasting short interframe space information to aid in determining a round trip time are provided. The round trip time is used as an aid in locating nodes within a WiFi or WLAN network. The method begins with capturing a time of transmission of a frame by a transmitting station. The receiving station then captures the time of arrival of the frame just sent by the transmitting station. The receiving station replies with a received frame message and the time of departure is captured. The transmitting station then captures the time of arrival of the received frame message. The captured arrival and departure times of the frame and the received frame message allow the round trip time to be computed. The RTT may then be included as part of a network message.

### BACKGROUND

1. Field

The present disclosure relates generally to communication systems, and more particularly, to broadcasting short interframe space (SIFS) information to aid in determining round trip time (RTT), which may then be used as an aid in locating nodes in a short range wireless network. In addition, the disclosure relates to ascertaining the quality of the SIFS information received.

2. Background

Indoor networks are increasingly being used in businesses and homes to provide network connectivity over a small area, such as an office building or home. Indoor location devices are often based on WiFi and may function as a wireless local area network (WLAN). The network consists of multiple nodes that provide WiFi signals to devices within range. In order for the WiFi network to function smoothly the range between two nodes must be determined. To determine the range between two nodes two independent measurements may be used to assess the range: received signal strength indicator (RSSI) and round trip time (RTT).

RSSI is a relative indicator of signal strength above the noise floor and can also be an absolute measurement of power. RTT captures the amount of time between the transmission of a unicast packet, such as a data packet, by an initiator node to a remote target node and the reception of the appropriate response packet, which may be an acknowledgement (ACK) or clear to send (CTS), as measured by the initiating station. RTT is typically measured in nanoseconds.

New chip designs may allow recording of the time of departure (TOD), from the sending or initiating station and also time of arrival (TOA), using timestamps. The timestamps permit measurement of RTT. In measuring RTT there is a variable amount of turnaround time delay involved at the target, or receiving node, that needs to be accounted for before RTT time may be used for ranging calculations. These ranging calculations using RTT are made by extracting the time of flight between the two nodes, which requires knowledge of the turn-around calibration factor (TCF). TCF may be implementation specific and may depend on the short interframe space (SIFS), time of arrival uncertainty, and other delays at the target node. The TCF varies depending on the chipset used by the remote target node.

There is a need in the art for a method of measuring the SIFS interval by a remote node, with that remote node sending the SIFS interval in a message to the sending or initiating node for use in ranging calculations. In addition, there is a need in the art for assistance in estimating the turn around calibration factor (TCF) accurately. The TCF is then used for computing the range estimate.

### SUMMARY

Embodiments disclosed herein provide a method for estimating a position of a wireless node in a communication system. The method comprises computing a round trip time (RTT) using a turn-around calibration factor (TCF) and then comparing the computed RTT with the RTT values of other nodes in the communication system. The position of the wireless node may then be estimated based on the comparison of the RTTs.

A further embodiment provides an apparatus for estimating RTT. The method begins with capturing a time of transmission of a frame by a transmitting station. The time of arrival of that frame is then captured by a receiving station. The time of departure of the received frame message is captured by the transmitting station. The time of arrival of the received frame message is then captured by the receiving station. The RTT may then be computed based on the captured time of arrival and the captured time of departure of both the frame and the received frame message and a TCF.

Yet a further embodiment provides an apparatus for estimating a RTT. The apparatus includes: a processor for computing a RTT of a frame using a TCF, a processor for comparing the computed RTT with RTTs of other nodes in the communication system, and a processor for estimating the position of the node based on the comparison of the RTTs.

A still further embodiment provides an apparatus for estimating a RTT. The apparatus comprises: a processor for capturing a time of transmission of a frame, a processor for capturing a time of arrival of a frame, a receiving for receiving a time of arrival of a frame, a processor for computing a RTT using a TCF, and a transmitter for transmitting a computed RTT as part of a network message.

A still further embodiment provides an apparatus for estimating a position of a wireless node in a communication system. The apparatus is comprised of the following elements: means for computing a RTT of a frame using a TCF, means for comparing the computed RTT with RTTs of other nodes in the communication system; and means for estimating the position of the node based on the comparison of the RTTs.

An additional embodiment provides an apparatus for estimating a position of a wireless node in a communication system. The apparatus is comprised of: means for capturing a time of transmission of a frame by a transmitting station, means for capturing a time of arrival of the frame sent by the transmitting station by a receiving station, means for capturing a time of departure of a received frame message by the transmitting station; and means for computing a RTT based on the captured time of arrival and the captured time of departure of both the frame and the received frame message and a TCF.

Yet a further embodiment provides a non-transitory computer-readable medium that contains instructions, which when executed by a processor, cause the processor to perform the steps of: computing a RTT of a frame using a TCF, comparing the computed RTT with RTTs of other nodes in the communication system; and estimating the position of the node based on the comparison of the RTTs.

A still further embodiment provides a non-transitory computer-readable medium containing instructions, which when executed by a processor, cause the processor to perform the steps of: capturing a time of transmission of a frame by a transmitting station, capturing a time of arrival of the frame sent by the transmitting station by a receiving station, capturing a time of departure of a received frame message by the transmitting station, capturing a time of arrival of the received frame message by the transmitting station, and computing a RTT based on the captured time of arrival and the captured time of departure of both the frame, the received frame message and a TCF.

### BRIEF DESCRIPTION OF THE DRAWINGS

FIG. 1 depicts the departure time (DT) and arrival time (AT) to be returned by the WLAN driver, according to an embodiment of the application.

FIG. 2 is a block diagram of the process of computing the RTT, according to an embodiment.

FIG. 3 illustrates the frame format with TOA/TOD markers, according to an embodiment.

FIG. 4 depicts the distributed coordination function (DCF) timing relationships, according to an embodiment.

FIG. 5 depicts the TCF and RTT definitions, according to an embodiment.

FIG. 6 is a flow chart of a method of measuring the SIFS information for location purposes, according to an embodiment.

FIG. 7 illustrates the SIFS element format for broadcasting, according to an embodiment.

FIG. 8 illustrates the format of a request to send (RTS) packet, according to an embodiment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

An OFDMA network may implement a radio technology such as Evolved UTRA (E-UTRA), the Institute of Electrical and Electronics Engineers (IEEE) 802.11, IEEE 802.16, IEEE 802.20, Flash-OFDAM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. The techniques described herein may be utilized in various application involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Wireless networks such as those described above, are increasingly being used in conjunction with smaller local networks for internet access and other services. WiFi is one example of such local networks. WiFi is a popular technology that allows an electronic device to exchange data wirelessly (using radio waves) over a computer network, including high-speed Internet connections. The WiFi Alliance defines WiFi as “any wireless local area network (WLAN) product that are based on the Institute of Electrical and Electronics Engineers (IEEE) 802.11 standards.”

A device that may use WiFi may be a personal computer, video game console, smartphone or digital audio player. The device connects to a network resource such as the Internet via a wireless network access point. Such an access point may also be known as a hotspot. These access points have a range of approximately 65 feet indoors with the range slightly greater outdoors. Hotspot coverage may comprise an area as small as a single room with walls that block radio waves or may be as large as several miles when overlapping access points are connected.

WiFi technologies based on the IEEE 802.11 standard are enforced by the WiFi Alliance. This includes wireless local area network (WLAN) connections, device to device connectivity (such as WiFi Peer to Peer, also known as WiFi Direct), personal area network (PAN), local area network (LAN) and even some limited wide area network (WAN) connections are covered by the WiFi Alliance and versions of IEEE 802.11.

In order to connect to a WiFi LAN, a computer or other device must be equipped with a wireless network interface controller. The combination of the computer or device may be known as a station. All stations share a single radio frequency communication channel. Transmission on this channel is received by all stations within range. The hardware does not signal the user that the transmission was delivered and therefore, the delivery mechanism is known as a “best effort” delivery mechanism. A carrier wave transmits the data in packets, which may be referred to as “Ethernet frames”. Each station is constantly tuned to the radio frequency communication channel in order to receive available transmissions.

A WiFi enabled device may connect to the Internet or other resource when within range of a wireless network. WiFi may provide service in private homes, coffee shops and other businesses, hospitals and organizations such as airports, hotels and others.

Service is provided by routers that may incorporate a digital subscriber line modem or cable modem that is connected to the WiFi access point. This connection may be either wired or wireless. When subscribed to a cellular phone carrier, access points allow nearby WiFi stations to access the Internet or other network over 2G, 3G, or 4G networks. Many smartphones also include the capability of serving as a WiFi access point and stand alone facilities that provide internet access, such as MIFi and WiBro are also available.

WiFi also allows direct computer to computer communication without using an access point as an intermediary. This is known as ad hoc WiFi communication and may be used by handheld game consoles, digital cameras and other portable electronic devices. Some of these devices may also share their Internet connection, making them “virtual routers”.

WiFi offers the advantage of cheaper network deployment for LANs and is often used where cables cannot be run, such as outdoor areas and historical buildings. Most recent consumer devices include wireless network adapters, thus helping to foster use of the technology.

One drawback to WiFi networks is their limited range. A typical wireless access point using IEEE 802.11-b or IEEE 802.11-g with a stock antenna may have a range of 120 feet indoors and 300 feet outdoors. This range may be more than doubled by using an IEEE 802.11-n network. Range may also vary with frequency band. WiFi in the 2.4 GHz band has a slightly better range than WiFi in the 5 GHz band used by IEEE 802.11-aa and is optional for IEEE 802.11-n. On wireless routers with detachable antennas, it is possible to improve the range by fitting an upgraded antenna with higher gain in the desired direction. This may be particularly effective in outdoor applications. Thus, effectively computing range is an important consideration in establishing a WiFi access point within a network.

WiFi signatures may be used for indoor positioning by mapping the WiFi signatures to expected values at any given region in the map to obtain a probabilistic position. Two WiFi signatures, received signal strength indicator (RSSI) and round trip time (RTT) may be used for positioning a mobile device. The position estimation may be made because the distance between wireless nodes, such as an access point (AP) and a mobile station (MS) may be estimated based on the RTT between the wireless nodes.

Based on multiple RTT measurements between a MS and multiple APs, the location of the MS may be estimated. RTT calculation is described in detail below. For clarity, certain aspects of the techniques and methods are described below for WiFi, and WiFi terminology is used in much of the description below. It should be noted that the WiFi terminology is used by way of illustration and the scope of the disclosure is not limited to WiFi technologies.

FIG. 1 shows the departure time (DT) and arrival time (AT) to be returned as part of the operations described further below. Indoor location software 106, WLAN driver 108, and WLAN chip hardware 110 form the active components for initiator 102. Target 104 includes remote target node 112. The DT and AT are to be returned by the WLAN driver 108 to the indoor location software 106 for the transmit (Tx) event Tx_event, and the receive (Rx) event, Rx_event between the initiator 102 and target node 104. DT is a timestamp that may represent the end of the last orthogonal frequency division modulated (OFDM) symbol of the Tx_event packet at the transmit antenna port of initiator 102. The Tx packets for the RTT measurement may not send delayed replicas of the Tx packets from multiple transmitter chains in order to ensure that the timestamp is unique. This may mean that the transmission occurs on only one of a number of possible transmit chains. The DT measurement may be 0.1 nanosecond in precision in some embodiments. The precision may vary depending on the granularity or accuracy of positioning needed by a particular system.

AT is a timestamp that may represent the beginning of the start of the preamble of the Rx_event at the receive antenna port of initiator 102. Since it may not be possible to control the number of transmitter chains used by the remote target node 112, the response packet may be transmitted as cyclic shift diversity (CSD) delayed replicas from multiple antennas of the target node 104. If this is done, the AT returned by the WLAN driver software 108 will represent the earliest arrival replica. This measurement may also be 0.1 nanosecond in precision in some embodiments. The precision may vary here as well depending on the network.

Round trip time (RTT) is computed by the WLAN driver software 108 as described below. The equation used is:

RTT=AT−DT

The computed RTT value is returned to indoor software location module 106.

The RTT definition given above establishes points of reference that may be used in an ideal scenario, where there is no need for discretization and quantization of samples that constitute OFDM symbols. However, in practical implementations, the discrete sampling quantization and accuracy may only be sufficient to reliably sustain the OFDM link for the given signal to noise ratio (SNR) budget.

FIG. 2 is a block diagram of an embodiment of computing the RTT, which illustrates the various time stamps affecting the RTT computation. The sending station, namely the initiator node, sends a message at time t1. This message is received at the receiving station, the target node, at time t2. The target node then sends a response message, such as an acknowledgement (ACK) for example, at time t3, which is received by the initiator node at time t4. The message begins to be sent at the initiator node at time t1 and the sending of the message is complete at time t1′. The message begins to be received at the target node at time t2 and reception is complete at time t2′. The same holds true for the response message, such as an ACK, which begins to be sent at time t3 with sending complete at time t3′. Reception of the response message begins at time t4, and is completed at time t4′. The RTT may be computed using the following expression:

RTT=(t2−t1)+(t4−t3)=(t2′−t1′)+(t4−t3)=(t4−t1′)−(t3−t2′)=TOA(t4)−TOD(t1′)−TCF(t3−t2′) where TOA refers to time of arrival and TOD refers to time of departure at the initiating node.

TCF (shown above as (t3−t2′) may be a short interframe space (SIFS) time plus uncertainty in time of arrival. The SIFS time may be described mathematically by the equation below:

aSIFS time=aRxRFDelay(unknown)+aRxPLCPDelay(unknown)+aMACProcessingDelay(less than 2 μs)+aTxPLCPDelay(unknown)+aRxTxSwtichtime(much less than 1 μs)+aTxRampOnTime(unknown)+aTxRFDelay(unknown).

The RxTxTurnaround time=the sum of TxPLCPDelay+RxTxSwitchTime+TxRampOnTime+TxRFDelay, which is less than 2 μs. The unknown values are implementation dependent and will vary with the particular network and operating parameters established by the network operator.

When sending a packet the receiving stations needs to reply within the short interframe space (SIFS) interval. The SIFS is the time from the end of the last symbol, or signal extension, if present, of the previous frame to the beginning of the first symbol of the preamble of the subsequent frame as seen at the air interface. If this SIFS interval is known, the RTT may be computed. However, IEEE 802.11 a/b/g/n/ac requires that the SIFS time is 16 μs+/−10% of the slot time (9 μs). The IEEE 802.11 standards thus require that the SIFS be within 15.1 μs and 16.9 μs. As a result, SIFS values may vary somewhat. The methods described below provide that upper and lower boundary values for the RTT. RTT is defined as the round trip time that the physical (PHY) layer requires to have a signal traverse a medium and back. In the IEEE 802.11 standard the SIFS timing is to be achieved when the transmission of the subsequent frame is started at the transmit short interframe space (TxSIFS) slot boundary. The space between frames that are defined to be separated by a SIFS time, as measured on the medium, is not allowed to vary from the nominal SIFS value by more than +/−ten percent of a slot time for the physical layer in use, under the IEEE 802.11 standard.

The SIFS is an example of interframe spaces between transmission from different stations. It is used when stations have seized the medium and need to keep it for the duration of the frame exchange sequence to be performed. Using the smallest gap between transmissions within the frame exchange sequence prevents other stations, which are required to wait for the medium to be idle for a longer gap, from attempting to use the medium, thus giving priority to completion of the frame exchange sequence in progress.

The RTT value allows the two stations to find themselves with respect to one another. If one station knows when it transmits, the other station knows when it receives the packet, which allows computation of the RTT. In addition, the RTT value also allows estimating the distance between two wireless nodes.

The WLAN driver adjusts for the implementation specific artifacts and attempts to return DT and AT values as close to those of the ideal scenario as possible. An example of adjusting for implementation specific artifacts is given below.

A chipset enables recording of a TOD time stamp in high resolution mode (which may use a 44 MHz clock). The TOD corresponds to the start of the long training field (LTF) symbol of the transmitted packet at the MAC-base band (BB) interface.

FIG. 3 illustrates the IEEE 802.11 frame formats and the marker in the preamble corresponding to the TOD and TOA timestamps for the chipset. FIG. 3 also shows the desired DT and AT markers from the frame, which should be corrected for the antenna reference plane. TOD capture is made by the chipset at the MAC-BB interface, which incurs additional delays as propagation progresses through the baseband and RF conversion chain. The WLAN driver must account for these delays in making the RTT calculation. The TOD for the chipset may be obtained from the TOD using the formula below.

DT=TOD+6.4 μs*No. OFDMSymbols+Tx_{BB}+Tx_{RF}

In a similar fashion, the AT may be obtained from the TOA, using the formula below.

AT=TOA−(1.6 μs+8 μs)−Rx_{BB}−Rx_{RF}

Thus, the RTT that the WLAN driver reports may be computed as:

RTT=AT−DT=TOA−TOD−TxframeLen−(Tx_{BB}+Tx_{RF}+Rx_{BB}+Rx_{RF})

The multipath correction factor is also applied to the computed RTT by the WLAN driver.

FIG. 4 illustrates the DCF timing relationships, which are used in calculating the RTT. The turn around calibration factor may be defined as the time difference, or delta, between the end of the last symbol of the Tx packet received at the antenna of the target node and the beginning of the preamble of the response packet. The response packet may be an ACK or CTS packet. The response packet is starting to be transmitted at the antenna of the target node.

FIG. 5 depicts the definitions of the TCF and RTT. The system 500 includes initiator 502 which sends Tx Packet 506 to target 504. The target sends Rx packet 508 back to initiator 502 to complete the response scenario. On both the transmit and receive paths multipath interference may occur. In the event that the target node uses more than one transmit chain with cyclic shift diversity (CSD) delayed replicas to send the response packet (in IEEE 802.11n), then the earliest replica is used for defining the TCF. The TCF is measured independently using the equipment placed near the target node. The TCF defined above, is thus equivalent to the SIFS time described above plus the uncertainty in time of arrival. Once the SIFS time is known and the calculations are complete, range may to the node may then be computed using the formula:

Distance=(RTT−TCF)*speed_of_light/2

From this equation, an estimate of SIFS may be obtained by collecting a series of RTT measurements between 2 known locations and removing the uncertainty of time of arrival. A sample equation is given below:

$$SIFS = \frac{{\sum }_{i = 1}^{N} RTT ( i )}{N} \times 2 * distance \text{/} Speed of light$$

FIG. 6 is a flowchart of a method for computing the round trip time for locationing purposes. The method, 600 begins with the capture of the time of frame transmission in step 602. Next, in step 604, the arrival time of the frame is captured. In step 606, the departure time of the received frame message is captured. In step 608, the arrival time of the received frame message is captured. Finally, in step 610 the round trip time is computed, allowing the location of the remote node to be determined.

FIG. 7 illustrates the format of the SIFS information element that is used when transmitting the SIFS information. The element 700, includes ID field 702, which is set equal to 222. A length field equal to nine is provided in field 704. Field 706 provides for Delta_min and field 708 provides for Delta_max. Field 710 is an optional field, a low density parity check (LDPC) field, used only when LDPC is provided. The LDPC bit is used indicate whether the SIFS range is with the LDPC enabled, (1 in the field) or not (0 in the field). Field 712 is another optional field, for space time block coding (STBC) when this option is used. The STBC bit indicates whether the SIFS range is with the STBC enabled (1 in the field) or not (0 in the field). The octet values are also provided in FIG. 7.

The SIFS is used prior to transmission of an acknowledgement (ACK) frame, a clear-to-send (CTS) frame, a physical layer protocol data unit (PPDU) containing a BlockAck frame that is an immediate response to either a BlockAckReq frame, or an aggregate medium access control protocol data unit (A-MPDU), the second or a subsequent medium access control protocol data unit (MPDU) of a fragment burst, and by a station responding to any polling by the point coordination function (PCF).

The SIFS information element format shown in FIG. 7 is used in conjunction with the computation methods described earlier. Ideally, the SIFS is 16 μs and the IEEE 802.11 standard allows for +/−900 ns of slack time. Rather than transmitting both the SIFS_min value and SIFS_max value, an embodiment provides for the transmission of Delta_min, which is 32 bits, and Delta_max, which is also 32 bits. This is done because transmitting both SIFS_min and SIFS_max values would require too many bits when 0.1 ns resolution is used. The relationship between SIFS_min and SIFS_max and Delta_min and Delta_max is given by the equations below:

SIFS_min=SIFS standard value+Delta_min

SIFS_max=SIFS standard value+Delta_max

Delta_min<=Delta_max.

The SIFS value may be given by the IEEE 802.11 standard and provides a preferred value for SIFS. The IEEE 802.11 standard has various incarnations, each of which may specify a different SIFS interval. These intervals may be as low as 16 μs or as high as 160 μs.

In this embodiment, Delta_min and Delta_max are both quantized to 0.1 ns resolution.

When used in positioning calculations, the RTT measurement may be acknowledged by an AP. In this case, an AP acknowledges a unicast packet reception from a MS with an acknowledgement frame. This acknowledgement packet may use a different packet type for each request, for example, ACK may be used to acknowledge DATA, a CTS packet may be used to acknowledge RTS. Other packet types may also be used.

FIG. 8 depicts an RTS packet that may be used for RTT measurements. In the IEEE 802.11 specification, successful reception of a unicast packet is followed by the transmission of a response packet. This response packet is transmitted after a fixed delay period has elapsed. In FIG. 8, RTT indicates the time elapsed between the end of the departure time (T₀) of the probe packet. This time is computed at the MS, the source of the response packet. In addition, RTT indicates the start of the reception time (T_{f}) of the acknowledgement from the destination node, here, the MS. The hardware may measure the SIFS+RTT. This may be done by measuring the time difference T_{f}−T₀ in terms of the number of clock cycles. If this fixed delay is constant, the SIFS is a constant. If the SIFS is a constant, then the RTT may be computed. It should be noted that multipath effects and other sources of error must also be considered. To obtain RTT measurements from multiple access points, it is not necessary that the STA be associated with all of those access points. Normally in an IEEE 802.11 system, the reception of a unicast frame, such as RTS or DATA(NULL) is responded to with a CTS or ACK frame, respectively.

T₀ and T_{f} should be accurately measured in order to obtain a good estimate of the RTT, and hence, the distance, and ultimately the positioning estimate. The accuracy of the SIFS measurement may directly affect the timing estimate used to computer the RTT. As a result, SIFS time resolution, that is, the number of bits required for a sample duration of 25 ns or 50 ns, for example, and the distribution, which may be standard deviation have significant influence on the accuracy of the RTT estimation. This is significant because each nano second accounts for approximately one foot of distance traveled by an electromagnetic wave. Thus, small errors in RTT determination result in an incorrect SIFS determination which may yield a position estimate off by multiple feet.

Theoretically the SIFS could be estimated by examining multiple measurements and computing an average SIFS value. However, knowing the SIFS value in advance may increase the positioning accuracy and decrease network bandwidth usage.

An embodiment provides for incorporating a given AP's SIFS to the MS. This may be accomplished by adding an additional field or fields to the headers specified by the IEEE 802.11 standard. The embodiment provides for two additional fields that may be added to the IEEE 802.11 header to report SIFS timing characteristic of a MS. The two added fields may be a mean SIFS value and standard of deviation of the given wireless node.

For mobile station based positioning, the SIFS standard deviation may provide a baseline for the standard of deviation of the RTT measurement made by a mobile station. Therefore, the distribution of the estimated distance between an AP and the MS is provided. For network based positioning, the SIFS standard deviation may provide a baseline for the standard deviation of the RTT measurement made by mobile station.

The standard deviation of the RTT may be used as a confidence measure of the range estimation, which may be considered in positioning estimation as the particle filter. In other words, if the standard deviation is high the AP may not be reliable. The standard deviations may be input in a Bayesian determination and weighted so that the higher quality APs are weighed more heavily.

A further embodiment provides that instead of directly incorporating the standard deviation or other timing characteristics in the frame, then a bit may be added that indicates that the wireless node is RTT capable. This may occur if the mean or standard deviation information is too much information to be contained within the frame. An example of this type of use may occur if the standard deviation is less than a certain threshold, then the node is considered to be RTT capable. The threshold for determining RTT capability may be less than 200 ns, or some other suitably selected value, depending on the system and IEEE 802.11 standard in use. This threshold may also be defined by the positioning entities.

A still further embodiment may provide for a positioning frame packet exchange where the AP responds with an ACK frame that includes the standard deviation and SIFS information.

Yet a further embodiment may provide for the standard deviation and SIFS information may be included in the beacon frame as an information element. These embodiments provide that in an IEEE 802.11 medium access control (MAC) header, one bit may be added to indicate RTT capability. In this embodiment, if this bit is set to true, then an additional field may be added to define the mean SIFS. The accuracy may then be determined by the number of bits required for representing the time in clock duration, such as 12.5 ns for 80 MHz, or 25 ns for 40 MHz, and 50 ns for 20 MHz, with other values possible for other frequencies.

In further embodiment, two fields mean and standard deviation of SIFS of a given wireless node may be added to the 802.11 MAC header to report a SIFS timing characteristics of an wireless nodes. For mobile based positioning, the SIFS standard deviation provides a baseline for the standard deviation of the RTT measurement of an AP, therefore the distribution of the estimated distance between an AP and the MS. For network based positioning, the SIFS standard deviation provides a baseline for the standard deviation of the RTT measurement of an MS. There standard deviation of RTT can be used as confidence measure of the range estimation which can be considered in positioning estimation such as the particle filter.

In yet another embodiment, instead of directly incorporating the standard deviation (or other timing characteristics) in the frame, one bit may be used to indicate RTT capability of a wireless node. For example, if the standard deviation is lesser than a certain threshold, the node is considered to be RTT capable. This can be defined by the positioning entities. Therefore, in 802.11 MAC header, 1 bit may be added to indicate RTT capability. If this is set to true, then additional field may be added to define mean SIFS. The accuracy will be determined by the number of bits required for the representing the time in clock duration e.g. 12.5 ns for 80 MHz, 25 ns for 40 MHz, 50 ns for 20 MHz etc.

The packet and information exchanges described in the embodiments above may be done between the STA and the AP without requiring association. For standardization purposes, a packet may be defined that is unicast and requires a response frame from the access point irrespective of whether the access point is associated or unassociated.

In a further embodiment, the Turn-Around Calibration Factor (TCF) may be provided as part of the WLAN Enhanced Cell-ID Positioning assistance data. One format of the WLAN Enhanced Cell-ID Positioning assistance data may be provided by the Long Term Evolution Positioning Protocol Extensions (LPPe) protocol defined by the Open Mobile Alliance Location Working Group (OMA LOC). The LPPe assistance data may be provided on a point-to-point basis from a location server to a terminal, or it may be broadcast to multiple terminals (point-to-multi-point).

LPPe may be used in a user plane location architecture, such as the OMA Secure User Plane Location (SUPL) to provide location based services. In addition, SUPL/LPPe may also be used to exchange information between a location server ((SUPL) location platform (SLP)) and a terminal ((SUPL enabled terminal (SET)).

The LPPe WLAN Enhanced Cell-ID positioning assistance data may provide assistance for terminal-based and terminal-assisted WLAN positioning method and may also include WLAN Access Point data. This data may include the type of WLAN access point (e.g., IEEE 802.11a/b/g/n, or similar), transmit power of the access point (e.g., transmit power of beacon frames used by the access point), location coordinates of the access point, and the TCF of the access point. This assistance data information may be used for terminal-based location estimation methods. Once a terminal has received such assistance data (for example, in a LPPe Provide Assistance Data message), it may measure RTT to one or more access points as described above and may also use the TCF as provided in the assistance data of each measured access point to compensate for the internal delay of the measured access point. To obtain the RTT measurements from multiple access points, it is not necessary for the STA to be associated with all of the access points. Typically, in an IEEE 802.11 system, the reception of a unicast frame such as RTS or DATA(NULL) is responded to with a CTS or ACK frame, respectively. As one example, the terminal may determine the distance from the access point as (RTT-TCF) &speed of light/2. This distance estimate may then be used by the terminal together with the location coordinates of the access point in order to determine the location of the access point.

The TCF provided in the WLAN Enhanced Cell-ID Positioning assistance data may be in any format defined above, including, but not limited to: SIFS_min, SIFS_max, Delta_min, or a mean and standard deviation of the SIFS.

The OMA LPPe protocol also supports the terminal-assisted WLAN location method, where the target terminal measures RSSI or RTT, and provides the measurements to a location server, such as a Secure User Plane Location (SUPL) Platform (SLP), an evolved Serving Mobile Location Center (eSMLC), a Serving Mobile Location Center (SMLC), a Gateway Mobile Location Center (GMLC), a Position Determination Entity (PDE), a Standalone SMLC (SAS), or similar. The measurements may be provided by the terminal to a server in an LPPe Provide Location Information message. The RTT measurement information may also include information on whether the RTT measurement has been compensated for in the TCF. This information assists the location server in advantageously using the RTT measurements.

If the RTT information provided by the terminal does not indicate that the RTT provided compensates for the TCF (for example, the RTT provided is RTT=AT−DT, as described above), the location server may adjust the RTT provided with a TCF known by the location server for the measured access point, or access points (e.g., from a data base in the location sever.) In an alternate scenario, if the RTT information provided by the terminal indicates that the provided RTT already incorporates compensation in the TCF, then no further calibration steps are required at the location server, and the provided RTT may be used directly by the location server to determine the distance between the access point and the terminal, and may also be used to determine the terminal location. Therefore, in some embodiments, the location server may use the information on whether the provided RTT has been compensated for in the TCF or not, may advantageously determine whether the RTT requires additional processing for position determination. This may avoid location error when the provided RTT has already been compensated for in the TCF by the terminal, but the location server applies additional compensation.

The information regarding compensation in the RTT provided in the TCF may provided as a Boolean indication, where TRUE may indicate that the provided RTT has already been compensated for in the TCF, and FALSE may indicate that the provided RTT has not been compensated for in the TCF.

In further embodiments, the information concerning the provided RTT and any compensation for the TCF may be provided in the form of an actual TCE value used by the terminal for compensating the RTT measurement (for example, the value of the TCF used by the terminal in nano-seconds).

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for estimating a position of a wireless node in a communication system, comprising:
computing a round trip time (RTT) of a frame using a turn-around calibration factor (TCF);
comparing the computed RTT with RTTs of other nodes in the communication system;
estimating the position of the node based on the comparison of the RTTs.

2. The method of claim 1, further comprising;
recording a departure time for a transmit event; and
refraining from sending replicas of transmit packets from multiple transmit/receive chains to ensure that the departure time is correctly recorded in a timestamp.

3. The method of claim 1, further comprising:
computing an arrival time of a packet, wherein the packet is transmitted as a replica from multiple antennas of a target node.

4. The method of claim 1, where the TCF is a short interframe space (SIFS).

5. The method of claim 1, where the SIFS includes uncertainty in time of arrival.

6. The method of claim 1, wherein the TCF is a time difference between a last symbol of a transmit packet received at an antenna of a target node and a beginning of a preamble of a response packet.

7. The method of claim 6, where the response packet is an acknowledgement message.

8. The method of claim 7, wherein the received frame message is returned at a predetermined interval.

9. The method of claim 1, where the TCF includes an uncertainty in a time of arrival of a frame.

10. The method of claim 5, wherein the SIFS information is provided in a broadcast message header.

11. The method of claim 10, wherein a field bit indicates if the SIFS range is enabled or not enabled.

12. The method of claim 5, wherein minimum and maximum variance of the SIFS value is transmitted.

13. The method of claim 5, wherein the SIFS value is provided in at least one of the following formats: SIFS minimum, SIFS maximum, mean and standard deviation of the SIFS.

14. A method for estimating a round trip time (RTT), comprising:
capturing a time of transmission of a frame by a transmitting station;
capturing a time of arrival of the frame sent by the transmitting station by a receiving station;
capturing a time of departure of a received frame message by the transmitting station;
capturing the time of arrival of the received frame message by the transmitting station; and
computing a RTT based on the captured time of arrival and the captured time of departure of both the frame and the received frame message and a turn-around calibration factor (TCF).

15. The method of claim 14 wherein the RTT includes information on compensation in the turn-around calibration factor.

16. The method of claim 15 wherein if the SIFS value is less than a predetermined threshold, the node is deemed RTT capable.

17. The method of claim 16, wherein a standard deviation is included in the turn-around calibration factor, and transmitted in a beacon message.

18. An apparatus for estimating a position of a wireless node in a communication system, comprising:
a processor for computing a round trip time (RTT) of a frame using a turn-around calibration factor (TCF);
a processor for comparing the computed RTT with RTTs of other nodes in the communication system; and
a processor for estimating the position of the node based on the comparison of the RTTs.

19. An apparatus for estimating a round trip time, comprising:
a processor for capturing a time of transmission of a frame;
a processor for capturing a time of arrival of a frame;
a receiver for receiving a time of arrival of a frame;
a processor for computing a round trip time using a turn-around calibration factor (TCF); and
a transmitter for transmitting a computed round trip time as part of a network message.

20. An apparatus for estimating a position of a wireless node in a communication system, comprising:
means for computing a round trip time (RTT) of a frame using a turn-around calibration factor (TCF);
means for comparing the computed RTT with RTTs of other nodes in the communication system; and
means for estimating the position of the node based on the comparison of the RTTs.

21. An apparatus for estimating a position of a wireless node in a communication system, comprising:
means for capturing a time of transmission of a frame by a transmitting station;
means for capturing a time of arrival of the frame sent by the transmitting station by a receiving station;
means for capturing a time of departure of a received frame message by the transmitting station;
means for capturing the time of arrival of the received frame message by the transmitting station; and
means for computing a RTT based on the captured time of arrival and the captured time of departure of both the frame and the received frame message and a turn-around calibration factor (TCF).

22. The apparatus of claim 21, further comprising:
means for recording a departure time for a transmit event; and refraining from sending replicas of transmit packets from multiple transmit/receive chains to ensure that the departure time is correctly recorded in a timestamp.

23. The apparatus of claim 22, further comprising means for computing an arrival time of a packet, wherein the packet is transmitted as a replica from multiple antennas of a target node.

24. The apparatus of claim 22, wherein the means for computing RTT uses a short interframe space (SIFS) as the TCF.

25. A non-transitory computer-readable medium containing instructions, which when executed by a processor, cause the processor to perform the steps of:
computing a round trip time (RTT) of a frame using a turn-around calibration factor (TCF);
comparing the computed RTT with RTTs of other nodes in the communication system; and
estimating the position of the node based on the comparison of the RTTs.

26. A non-transitory computer-readable medium containing instructions, which when executed by a processor, cause the processor to perform the steps of:
capturing a time of transmission of a frame by a transmitting station;
capturing a time of arrival of the frame sent by the transmitting station by a receiving station;
capturing a time of departure of a received frame message by the transmitting station;
capturing the time of arrival of the received frame message by the transmitting station; and
computing a RTT based on the captured time of arrival and the captured time of departure of both the frame and the received frame message and a turn-around calibration factor (TCF).
